(19) United States
(12) Patent Application Publication
(10) Pub. No.: US 2024/0108022 A1
(43) Pub. Date: Apr. 4, 2024

(54) EDIBLE NON-ANIMAL DAIRY SUBSTITUTE PRODUCT COMPRISING FIBROUS MYCELIUM AS PROTEIN AND INSOLUBLE FIBER COMPONENT AND METHODS OF PRODUCING SUCH

(71) Applicant: MUSHLABS GMBH, Hamburg (DE)

(72) Inventors: Thibault GODARD, Hamburg (DE); Mazen RIZK, Hamburg (DE); Anne-Cathrine PREISSER, Hamburg (DE); Wassim W. AYASS, Hamburg (DE); Guido ALBANESE, Hamburg (DE)

(21) Appl. No.: 18/285,555

(22) PCT Filed: Apr. 14, 2022
(86) PCT No.: PCT/EP2022/060150

§ 371 Date: Oct. 4, 2023

(30) Foreign Application Priority Data
Apr. 15, 2021 (EP) 21168712.4

(51) Int. Cl. A23C 11/06; A23C 11/10; A23C 20/02; A23J 1/00; A23L 29/00; A23L 29/10

(52) U.S. Cl. CPC A23C 11/065; A23C 11/106; A23C 20/02; A23J 1/008; A23L 29/065; A23L 29/10; A23V 2200/264

(57) ABSTRACT

The present invention provides edible non-animal dairy substitute products comprising fibrous mycelium as protein component. The substitute products offer an even higher nutritional value compared to dairy products in terms of its high prebiotic insoluble fiber content critical for gut health. Such high fibrous ingredient is not known to be contained with such properties in dairy products. The edible non-animal dairy substitute product of the present invention is selected from products substituting milk, yoghurt, fresh cheese, whey cheese, cream cheese, medium-hard cheese, hard-cheese, and soft-mould cheese. The present invention is also concerned with methods of producing the edible non-animal dairy substitute products.

### FIELD OF THE INVENTION

The invention is in the field of edible non-animal dairy substitute products. The protein component of the edible non-animal dairy substitute products of the present invention is derived from fibrous mycelium mass of edible fungi.

### BACKGROUND

In Germany, around 8 million people are either vegetarian or largely forgo meat consumption, and 1.3 million people are vegan. The vegan trend can also be recognized globally, so the number of vegans has increased in the US from 1% in 2014 to 6% in 2019. The number of vegan-vegetarian people worldwide is estimated at 1 billion. To satisfy their needs, the food industry is developing more and more purely vegetable alternatives for well-known products. Although over the last years the focus has been on meat alternatives, classic dairy products, such as yogurt or cheese have also become more relevant because of climate discussions, animal welfare and lactose intolerance, in particular in Asia.

Dairy milk consumption has been on the decline for decades, with each generation drinking less milk than its predecessor does. A few years ago, there was usually only one non-dairy milk alternative readily available, which was usually based on soy. Other alternatives existed, such as almond milk, but were not as widely available. This has changed significantly in recent years.

It has been proposed that a part of the cause for this is due to changes in culinary tastes. Furthermore, there has been a shift in perception, especially in the younger generations, that a dairy-free diet is better and healthier. Further motivators to switch from dairy products to substitutes are the increased sustainability linked to the decreased environmental footprint of non-dairy products and concerns for animal welfare.

However, these non-animal alternatives need to have an attractive taste, a pleasant texture and an appealing color to attract more consumers in the first place. The second priority is their nutritional profile, which should be at least as good, if not better, compared to the products they intend to replace. Depending on the global region, sustainability or food safety criteria would rank third in terms of priority.

Non-dairy milk and yogurt are currently the biggest plant-based alternative product category in the US. The majority of the products are based on oat, soy, cashew and almond, with pea and lupins being less prominent. The switch from dairy products, such as milk to alternatives has now extended from milk to include other products like cheese.

Cheese alternatives, also known as cheese analogues, are products used as culinary replacements for cheese. Cheese analogues can also be called cheese substitute products. Various types of cheese analogues exist. Currently, many commercially available cheese analogues utilize a range of additives, such as thickeners, gelling agents, stabilizers and emulsifiers. Cheese analogues comprising these additives, especially those that are chemically modified, are not perceived by consumers as being a “natural food product”. Cheese analogues based on nuts, even if combined with gelling agents, do not exhibit a texture/rheological response to match that of cheese, specifically springiness or “stretchability” on baking. They have poor melting characteristics, so that cheese analogues, when present on a heated food product, do not display the stretch associated with regular molten cheese.

Hard cheese imitations are sold as block, sliced or grated cheese. They consist mainly of water, starch, coconut fat, flavor and colors, in some cases with additional plant-based proteins from pea, soy, potato or lupines or nuts like almond and cashew. After blending, these ingredients are heated to the gelling point of the stabilizer and then hot filled and cooled.

Commercial soft and fresh cheese alternatives as well as some hard cheese alternatives can be produced via traditional cheese making techniques as described in WO2018154095A1 by producing an aqueous solution of fruits or vegetables, acidifying it and coagulation by plant-based rennets, followed by moulding and ripening of the resulting curds.

Some commercial cheese analogues currently on the market are based on soy and typically contain casein, a dairy protein, and are hence not suitable for vegan consumers. In addition, soy contains some allergens such as lectins and may therefore not be adequate for those consumers sensitive to such molecules.

Therefore, current dairy alternatives not based on animal products have multiple nutritional challenges:

Firstly, they often comprise allergen-causing ingredients, such as oat (gluten), nuts (almonds and cashews) or soy.

Secondly, their carbohydrate, in particular sugars, and fat content is often significantly higher than animal-based milk analogue products.

Thirdly, either they contain less protein or the protein is not complete with the exception of soy-based products. Next to the nutritional effect, this is likely causing a flavour profile further away from the animal-based products as flavour components are mainly formed by proteolysis of proteins and metabolization of the resulting peptides and amino acids by specific lactic acid bacteria and yeasts as described in J. M. Kongo & F. X. Malcata, “Cheese: Chemistry and Microbiology”, Encyclopedia of Food and Health, Academic Press, 2016, Pages 735-740.

Most importantly, they naturally lack valuable micronutrients, such as calcium, iron, zinc, and phosphorus, which consumers seek in dairy products and/or need to seek out in other food products. To compensate for the lack of these micronutrients, some products contain calcium phosphates as food additives.

The last two factors are very critical as consumers rely on dairy products as an easily consumable and accessible source for proteins and calcium.

Furthermore, known cheese analogues generally have an off-taste, which in itself is unattractive, and masking of which by odors and flavors may require labelling of such compounds, which is also unattractive in view of the generally health-conscious consumer market for imitation cheese products. Although the environmental footprint of soy and nuts (almonds, cashews, etc.) is smaller than the one of dairy products, it remains significant. Therefore, there is a need for tastier, healthier and more sustainable cheese substitute products.

The present invention satisfies the above-mentioned needs.

Document US 2020/270559 discloses certain methods of production of edible filamentous fungal biomat formulations.

Document US 2020/060310 discloses certain myceliated vegetable protein and certain food compositions comprising same.

Document EP 3′366′144 discloses certain method for preparation of a vegan cheese.

### SUMMARY OF THE INVENTION

The present invention solves the above-mentioned challenges by introducing a new raw material to dairy replacement production, namely mycelia of edible mushrooms. Mycelia have been broadly applied in meat-replacement products because of their filamentous structure (GB2137226A) and as fat-mimicking substances in dairy drinks or yoghurts (WO2002090527A1).

CN212786880 reports that Pleurotus pulmonarius fruiting body is low in fiber content supporting the review published in 2021 (Fungal Biotec 1(2): 65-87 (2021)) summarizing the fiber content of the fruiting body of Pleurotus spp. that ranges from 2.97 wt % to at most 31 wt %, in particular the fruiting body of Pleurotus pulmonarius contains 4-9 wt % fiber on dry basis. CN105054261 also discloses the finding that when Pleurotus pulmonarius is mixed with other strains, a degradation of crude fibers takes place, especially on oyster mushrooms (Pleurotus spp.), thus reducing the fiber content by 2.3-20.25 wt %. Another study in 2020 (Int J Med Mushrooms. 2020; 22(7):651-657.doi:10.1615/IntJMedMushrooms.2020035449) also reveals that mycelia of oyster mushrooms (Pleurotus spp.) contains 22 wt % of insoluble fibers. Document US 2020/270559 discloses certain methods of production of edible filamentous fungal biomat formulations and shows nutritional data from two Fusarium filamentous fungi having a total fiber content up to 25 wt % and a fat content between 7 wt % and 12 wt %.

We developed an edible non-animal dairy substitute product comprising, a fibrous mycelium ingredient having at least 39 wt % of insoluble fibers, which also acts as a protein component of the present invention offering an even higher nutritional value compared to dairy products in terms of its high prebiotic insoluble fiber content critical for gut health. Such high fibrous ingredient is not known to be contained with such properties in dairy products.

In one embodiment of the invention, the mycelia are homogenized with water to produce an edible non-animal milk substitute product, also called a non-dairy milk replacement.

In a second embodiment of the invention, this non-dairy milk replacement is converted through fermentation into an edible non-animal yoghurt substitute product, also called a non-dairy yoghurt replacement.

In a third embodiment, the mycelia are blended with other ingredients to obtain an edible non-animal fresh cheese substitute product.

In a fourth embodiment, the mycelia are blended with other ingredients and, after coagulation, formed into a sliceable or grateable hard-cheese dairy analogue. Not only is the resulting cheese nutritionally better because of the added complete protein and prebiotic fiber, but the mycelium of the present invention also adds important micronutrients, such as vitamin B2, B3, B5 and B9 as well as key micronutrients like calcium and phosphorus in a biologically active form to the final product.

Flavour can also be significantly improved as the mycelia can bring a natural umami flavour typical to cheese without the usage of additional flavours, especially in the case when mycelium originates from a fungus that forms fruiting bodies, e.g. from Pleurotaceae, such as fungus selected from Pleurotus pulmonarius, Pleurotus ostreatus, Pleurotus citrinopileatus, Pleurotus florida, and Pleurotus salmoneostramineus, and specifically if derived from Pleurotus pulmonarius; or from a fungus selected from Morchella esculenta, Morchella angusticeps, Morchella deliciosa, and Morchella rufobrunnea, preferably Morchella rufobrunnea. This is due to a significant amount of glutamate present in such species along with other amino acids (e.g. aspartate) and/or 5′-nucleotides, which is in large part responsible for conveying the umami sensation.

The present invention is also concerned with methods of producing the above-mentioned edible non-animal dairy substitute products comprising the edible fibrous mycelium mass of the present invention. These methods will be described in detail below.

The present invention is also concerned with the use of an edible fibrous mycelium mass for producing an edible non-animal dairy substitute product, wherein the edible non-animal dairy substitute product is selected from products substituting milk, yoghurt, fresh cheese, whey cheese, cream cheese, medium-hard cheese, hard-cheese, and soft-mould cheese.

### DESCRIPTION OF THE INVENTION

In the following, the present invention will be described in detail.

The edible non-animal dairy substitute product of the present invention comprises an edible fibrous mycelium mass in the range of 1 wt % to 99 wt %, and water in the range of up to 99 wt %. In preferred embodiments, the edible non-animal dairy substitute product of the present invention comprises the fibrous mycelium mass in the range of 20 wt % to 95 wt %, more preferably in the range of 65 wt % to 90 wt %. In another preferred embodiment, the edible non-animal dairy substitute product of the present invention comprises the fibrous mycelium mass in the range of 1 wt % to 35 wt %. The ratio of mycelium mass to water can be chosen by the skilled person depending on the product to be substituted. The mycelium can be used directly after fermentation as a wet mycelium, it can be pressed to remove some water, it can be dried to remove water to reach a desired water content. The mycelium can also be dried and water can be added later to reach a desired water content. For example, the water content of the substitute product should be similar to the water content of the product to be substituted.

Preferably, in the edible non-animal dairy substitute product of the present invention, the edible fibrous mycelium has an insoluble fiber content of at least 39% w/w. More preferably, said edible fibrous mycelium has an insoluble fiber content of between 39% w/w and 60% w/w. Even more preferably, said edible fibrous mycelium has an insoluble fiber content of between 40% w/w and 55% w/w. Even more preferably, said edible fibrous mycelium has an insoluble fiber content of between 40% w/w and 50% w/w. Even more preferably, said edible fibrous mycelium has an insoluble fiber content of about 45% w/w. It is to be understood that the weight as referred to herein relates to dry mass of said mycelium. In one embodiment, the edible fibrous mycelium has an insoluble fiber content of at least 40% w/w, preferably of at least 50% w/w, more preferably of at least 60% w/w.

As understood herein, the term “insoluble fiber” preferably refers to part of the dietary fiber, which does not dissolve in water. Said insoluble fiber preferably comprises chitin and ß-glucan and is preferably distinguishable from the insoluble fiber of plant origin, which comprises plant cellulose and/or hemicellulose, but do not comprise chitin.

In a preferred embodiment the edible fibrous mycelium mass is derived from submerged fermentation. The submerged fermentation allows mycelia to grow without the need for a substrate, which supports them structurally like in solid-state fermentation. Additionally, growth rates are higher as nutrients can be transported to all points of the mycelia and it is easier to maintain sterile conditions. Depending on the fermentation conditions, the mycelia have the possibility to grow in the submerged fermentation into either pellets or threads. This structure is maintained at harvest, giving different texture properties to the resulting products, such as cheese products if processed mildly.

Furthermore, submerged fermentation provides the additional advantage that a clean product is obtained that is not contaminated with the residues of the solid substrates that can bring bad taste or allergies afterwards, in particular because washing of the mycelium grown in submerged fermentation can be easily achieved. Similarly, fermentation byproducts such as acids or alcohols that can alter the taste as well can also be easily removed.

In submerged fermentation, it is also easier to better control fermentation conditions such as pH and oxygen content. Therefore, it is easier to enable the maximal growth of the mycelium compared to substrate limitation in solid-state fermentation. Thus, a more homogenous product composition can be obtained, which also enables reduction of the variation from batch to batch.

Furthermore, the material obtained by submerged fermentation is more malleable and can be formed into any kind of shapes. For example, the mycelium can be homogenized into a liquid that can be fermented, which is particularly advantageous if the mycelium is used to produce a dairy substitute product. Mycelium obtained from solid-state fermentation is usually dried and therefore needs to be resuspended in water to get a milk like substance.

Furthermore, in submerged fermentation, spore formation or fruiting body formation that could lead to toxin production can be prevented easily and efficiently as the fermentation media can be agitated. It is further apparent to the skilled person that if the growth is performed in the submerged fermentation, preferably no differentiation of mycelium to spores and/or fruiting bodies occurs. Thus, it is apparent to the skilled person that the mycelium mass derived from submerged fermentation may also be referred to as non-differentiated mycelium biomass. The skilled person would recognize further advantages of using submerged fermentation, e.g. a better control over texture and composition of biomass compared to solid state fermentation.

Furthermore, submerged fermentation methods are easier to scale up, as a second culture can be inoculated with the first culture, as both cultures are in liquid state. This is not easily possible in solid state fermentation, as the first culture cannot flow. This disadvantage can in part be remedied by using a rotating drum reactor, wherein the reactor is rotated to mix the solids and the mycelium. Drums reactors, however, are known for their huge problem of heat transfer during fermentation that leads to different temperatures in the reactor. There may be parts of the fermentation volume that are overheated at some point because heat cannot be removed properly, or parts of the fermentation volume, especially at fermentation start, that are underheated. In submerged fermentation, the heat transfer will be more efficient as liquid is good at transferring heat, leading to more homogeneous heat distribution and thus a more controllable, more efficient fermentation process.

The edible non-animal dairy substitute product of the present invention is selected from products substituting milk, yoghurt, fresh cheese, whey cheese, cream cheese, medium-hard cheese, hard-cheese, and soft-mould cheese.

“Edible” in the context of the present invention means that the edible product is safe for humans to eat. The “non-animal dairy substitute product” of the present invention is a product that is suitable to substitute a dairy product and is not derived from an animal. The “non-animal dairy substitute product” of the present invention is particularly not a product that substitutes meat. The “non-animal dairy substitute product” can also be termed a vegetarian product, or even a vegan product. Suitability for substituting a dairy product is determined by texture, mouthfeel, taste, nutritional content, water content, appearance, and other factors, which should be as similar to the product to be replaced as possible.

The edible non-animal dairy substitute product of the present invention preferably comprises an edible fibrous mycelium mass having a protein content of between 10 wt % and 60 wt %, preferably between 20 wt % and 50 wt %, and most preferably between 25 wt % and 35 wt % of a dry mass of the fibrous mycelium mass. The protein content of the mycelium mass can be adjusted by choosing fermentation conditions, which control the protein content of the obtained mycelium mass. Such conditions are known to the skilled person and involve adjusting the contents of the fermentation medium to control the uptake and therefore the composition of the mycelium mass to be obtained. For example, the ratio between carbon and nitrogen source in the medium can be altered, such as providing nitrogen in different grades of excess.

The edible non-animal dairy substitute product of the present invention preferably has a phosphorus content from 40 to 500 mg per 100 g weight of the edible non-animal dairy substitute product, preferably from 60 to 250 mg per 100 g weight of the edible non-animal dairy substitute product.

In an embodiment, in the edible non-animal dairy substitute product of the present invention the edible fibrous mycelium may have a phosphorus content of at least 1000 mg per 100 g weight, preferably at least 2000 mg per 100 g weight, for example 2131 mg per 100 g weight. It is to be understood that the weight as referred to herein relates to dry mass of said mycelium. In one embodiment, in the edible non-animal dairy substitute product of the present invention the edible fibrous mycelium may have a phosphorus content of at least 120 mg per 100 g weight.

The edible non-animal dairy substitute product of the present invention preferably has a calcium content from 20 to 400 mg per 100 g weight of the edible non-animal dairy substitute product, preferably 25 to 400 mg per 100 g weight of the edible non-animal dairy substitute product, preferably from 40 to 250 mg per 100 g weight of the edible non-animal dairy substitute product.

In an embodiment, in the edible non-animal dairy substitute product of the present invention the edible fibrous mycelium may have a calcium content of at least 1000 mg per 100 g weight, for example 1331 mg per 100 g weight. It is to be understood that the weight as referred to herein relates to dry mass of said mycelium. In one embodiment, in the edible non-animal dairy substitute product of the present invention the edible fibrous mycelium may have a calcium content of at least 80 mg per 100 g weight.

The edible non-animal dairy substitute product of the present invention preferably has a zinc content from 0.5 to 5 mg per 100 g weight of the edible non-animal dairy substitute product, preferably from 0.3 to 4 mg per 100 g weight of the edible non-animal dairy substitute product.

Preferably, in the edible non-animal dairy substitute product of the present invention the edible fibrous mycelium has a fat content of 1 to 5 g per 100 g of said mycelium, preferably 2 to 4 g per 100 g of said mycelium, more preferably 2 to 3.5 g per 100 g of said mycelium.

The phosphorus content, the calcium content, the iron content, the manganese content, and/or the zinc content of the mycelium mass can be adjusted by choosing corresponding fermentation conditions, which control the respective contents of the obtained mycelium mass. Such conditions are known to the skilled person and involve adjusting the contents of the fermentation medium to control the uptake and therefore the composition of the mycelium mass to be obtained.

The above-mentioned adjustability of the composition of the mycelium mass of the present invention provides the advantage of versatility, wherein the composition of the mycelium mass can be easily adjusted to the requirements of the substitute product to be obtained. If the protein content of the mycelium mass is increased, the amount of mycelium mass in the substitute product can be decreased without changing the protein content of the substitute product, for example. If the substitute product is a certain type of cheese, which is characterized by certain amounts of calcium, phosphorus, and/or zinc, then these nutrients can be provided by the mycelium mass itself, obviating the need of supplementing the substitute product with additional nutrients externally. This decreases the costs of the production method and of the obtained product due to easier handling, fewer production steps, and decreased costs for raw material for the purpose of producing edible non-animal dairy substitute products with a clean label. Most importantly, the nutrients from the mycelia are bioavailable making the metabolic digestion predictable and easy, especially compared to products, which comprise nutrients supplemented externally.

In some embodiments, specifically when the edible non-animal dairy substitute product is a substitute product for yoghurt or cheese, the edible non-animal dairy substitute product can further comprise a texturizing agent, such as agar-agar, edible starch, guar gum, locust bean gum, wheat gluten, cellulose or derivatives of it. The texturizing agents give structure to the product, thereby making it suitable as a substitute product for yoghurt or cheese. The texturizing agent is however an optional component for the edible non-animal dairy substitute product of the present invention. If the water content of the mycelium homogenized with water is kept low by using a pressed or partially dried mycelium having a desired water content, the resulting mass will have the desired structure similar to that of yoghurt or cheese without the need of adding an external texturizing agent. The skilled person will know how to suitably adjust the water content of the mycelium mass to the substitute product to be produced.

The edible non-animal dairy substitute product can also comprise colorants and/or a flavorants, such as salt, extracts and/or spices. In certain preferred embodiments, the mycelium mass itself provides an umami flavor to the product. This is particularly the case if the mycelium mass is derived from fungal species that form fruiting bodies, e.g. from Pleurotaceae, such as fungus selected from Pleurotus pulmonarius, Pleurotus ostreatus, Pleurotus citrinopileatus, Pleurotus florida, and Pleurotus salmoneostramineus, and specifically if derived from Pleurotus pulmonarius; or from a fungus selected from Morchella esculenta, Morchella angusticeps, Morchella deliciosa, and Morchella rufobrunnea, preferably from Morchella rufobrunnea.

In further preferred embodiments, specifically when the edible non-animal dairy substitute product is a substitute product for yoghurt or cheese, the edible non-animal dairy substitute product further comprises an edible plant-, or algae-based fat component, a fat component derived from fungi or yeast. The fat component is preferably in the range of up to 60 wt %, preferably up to 25 wt %, and most preferably from 1 wt % to 5 wt %. The amount of the fat component can be adjusted depending on the product to be substituted.

The edible plant-based fat component is preferably selected from coconut oil, sunflower oil, rapeseed oil, palm oil, cottonseed oil, olive oil, canola oil, algae oil, or oleaginous yeast-derived oils.

In a further embodiment, the present invention relates to edible fibrous mycelium mass, as described herein. Preferably, the edible fibrous mycelium mass is derived from submerged fermentation.

Preferably, the edible fibrous mycelium has an insoluble fiber content of at least 39% w/w. More preferably, said edible fibrous mycelium has an insoluble fiber content of between 39% w/w and 60% w/w. Even more preferably, said edible fibrous mycelium has an insoluble fiber content of between 40% w/w and 55% w/w. Even more preferably, said edible fibrous mycelium has an insoluble fiber content of between 40% w/w and 50% w/w. Most preferably, said edible fibrous mycelium has an insoluble fiber content of about 45% w/w. It is to be understood that the weight as referred to herein relates to dry mass of said mycelium. In one embodiment, the edible fibrous mycelium has an insoluble fiber content of at least 40% w/w, preferably of at least 50% w/w, more preferably of at least 60% w/w.

Preferably, the edible fibrous mycelium has a phosphorus content of at least 1000 mg per 100 g weight, preferably at least 2000 mg per 100 g weight, for example 2131 mg per 100 g weight. It is to be understood that the weight as referred to herein relates to dry mass of said mycelium. In one embodiment, the edible fibrous mycelium has a phosphorus content of at least 120 mg per 100 g weight.

Preferably, the edible fibrous mycelium has a calcium content of at least 1000 mg per 100 g weight, for example 1331 mg per 100 g weight. It is to be understood that the weight as referred to herein relates to dry mass of said mycelium. In one embodiment, the edible fibrous mycelium has a calcium content of at least 80 mg per 100 g weight.

Preferably, the edible fibrous mycelium has a fat content of 1 to 5 g per 100 g of said mycelium, preferably 2 to 4 g per 100 g of said mycelium, more preferably 2 to 3.5 g per 100 g of said mycelium.

As it is recognized by the skilled person, an edible non-animal dairy substitute product is preferably characterized by a calcium content of between 80 mg/100 g product and 1350 mg/100 g product, and/or by a phosphorus content of between 120 mg/100 g product and 2200 mg/100 g product. For example, typical cheese has a calcium content of 600-800 mg/100 g of the product, and phosphorus content of about 700 mg/100 g of the product, and an edible non-animal cheese substitute product is expected to be characterized by a comparable calcium content and/or phosphorus content.

As it is to be understood herein, the edible fibrous mycelium preferably comprises at least one fungal strain. It is noted that the fibrous mycelium as described herein may also comprise more than one fungal strain. Thus, an expression that the mycelium mass is derived from a particular fungal strain is to be interpreted that said mycelium mass comprises said fungal strain, but other fungal strains may also be present. Preferably, said expression may be interpreted that said biomass comprises said fungal strain as the only fungal strain present in said biomass. Similarly, the expression that the mycelium mass is obtained from a particular fungal strain is to be interpreted that said mycelium mass comprises said fungal strain, but other fungal strains may also be present. Preferably, the expression that the mycelium mass is obtained from a particular fungal strain is to be interpreted that said mycelium mass comprises as the only fungal strain present in said biomass.

The mycelium mass of the present invention is derived from a fungal strain, which is selected from the division Basidiomycota or Ascomycota.

According to the present invention, the at least one fungal strain can be selected from the division Basidiomycota. Preferably, the at least one fungal strain selected from Basidiomycota can be a fungal strain selected from the subdivision Agaromycotina. As defined herein, a fungal strain selected from the subdivision Agaromycotina can be a fungal strain selected from the class Agaricomycetes. Preferably, a fungal strain selected from Agaricomycetes can be a fungal strain selected from the order Agaricales, Auriculariales, Boletales, Cantharellales, Polyporales, and Russulales.

When the fungal strain is selected from the order Agaricales, the fungal strain is preferably selected from the family Agaricaceae, Fistulinaceae, Lyophyllaceae, Marasmiaceae, Omphalotaceae, Physalacriaceae, Pleurotaceae, Schizophyllaceae, Strophariaceae, and Tricholomataceae.

The fungal strain selected from Agaricaceae can be Agaricus bisporus or Agaricus blazei, more preferably Agaricus bisporus.

The fungal strain selected from Fistulinaceae is preferably Fistulina hepatica.

The fungal strain selected from Lyophyllaceae is preferably Calocybe indica.

The fungal strain selected from Marasmiaceae is preferably Lentinula edodes.

The fungal strain selected from Omphalotaceae is preferably Caivatia gigantea.

The fungal strain selected from Physalacriaceae is preferably Flammulina velutipes.

More preferably, the at least one fungal strain selected from Agaricales can be a fungal strain selected from Pleurotaceae. Even more preferably, the at least one fungal strain of the present invention is a fungal strain selected from Pleurotus pulmonarius, Pleurotus ostreatus, Pleurotus citrinopileatus, Pleurotus florida, and Pleurotus salmoneostramineus, even more preferably selected from Pleurotus pulmonarius or Pleurotus ostreatus, most preferably Pleurotus pulmonarius.

The fungal strain selected from Schizophyllaceae is preferably Schizophyllum commune.

The fungal strain selected from Strophariaceae is preferably a fungal strain selected from Agrocybe aegerita and Hypholoma capnoides.

The fungal strain selected from Tricholomataceae is preferably a fungal strain selected from Hypsizygus tesselatus and Clitocybe nuda.

Alternatively, a fungal strain selected from Agaricomycetes can be a fungal strain selected from the order Auriculariales, more preferably a fungal strain selected from the family Auriculariaceae. Preferably, a fungal strain selected from Auriculariaceae is Auricularia auricula-judae.

When the fungal strain is selected from the order Boletales, the fungal strain is preferably selected from the family Boletaceae and Sclerodermataceae. The fungal strain selected from Boletaceae is preferably Boletus edulis.

When the fungal strain is selected from the order Cantharellales, the fungal strain is preferably selected from the family Cantharellaceae and Hydnaceae. The fungal strain selected from Cantharellaceae can be Cantharellus cibarius. The fungal strain selected from Hydnaceae can be Hydnum repandum.

When the fungal strain is selected from the order Polyporales, the fungal strain is preferably selected from the family Ganodermataceae, Meripilaceae, Polyporaceae, and Sparassidaceae

The fungal strain selected from Meripilaceae is preferably Grifola frondosa. The fungal strain selected from Polyporaceae can be from Polyporus umbellatus and Laetiporus sulphureus. The fungal strain selected from Sparassidaceae can be Sparassis crispa.

When the fungal strain is selected from the order Russulales, the fungal strain can be selected from the family Bondarzewiaceae and Hericiaceae. Preferably, a fungal strain selected from Russulales is a fungal strain selected from Hericiaceae, preferably selected from Hericium erinaceus and Hericium coralloides. The fungal strain selected from Bondarzewiaceae can be Bondarzewia berkeleyi.

According to the present invention, the at least one fungal strain can be selected from the division Ascomycota. Preferably, the at least one fungal strain selected from Ascomycota can be a fungal strain selected from the subdivision Pezizomycotina.

The fungal strain selected from Pezizomycotina can be selected from the class Pezizomycetes. Preferably, the fungal strain selected from Pezizomycetes can be a fungal strain selected from the order Pezizales. Preferably, the fungal strain selected from Pezizales can be selected from the family Morchellaceae and Tuberaceae.

Preferably, the fungal strain selected from Morchellaceae is Morchella esculenta, Morchella angusticeps, or Morchella deliciosa.

Preferably, the fungal strain selected from from Tuberaceae is Tuber magnatum, T. estivum, T. uncinatum, T. indicum, T. rufum or T. melanosporum, more preferably T. melanosporum and T. magnatum.

Alternatively, the at least one fungal strain selected from Ascomycota can be a fungal strain selected from the class Sordariomycetes.

Preferably, the fungal strain selected from Sordariomycetes can be a fungal strain selected from the order Hypocreales.

The fungal strain selected from Hypocreales can be a fungal strain selected from the family Cordycipitaceae. The fungal strain selected from Cordycipitaceae can be a fungal strain selected from Cordyceps militaris and Cordyceps sinensis.

Alternatively, a fungal strain selected from Hypocreales can be a fungal strain selected from the family Nectriaceae. The fungal strain selected from Nectriaceae can be a Fusarium strain.

In another embodiment, the fungal strain selected from Sordariomycetes can be a fungal strain selected from the family Sordariaceae. The fungal strain selected from Sordariaceae can be a Neurospora strain.

In preferred embodiments, the mycelium is not derived from Sordoriomycetes, in particular is not derived from the genus Neurospora, for example from Neurospora crassa or from the genus Fusarium, for example from Fusarium venenatum.

Preferably, the edible fibrous mycelium mass is obtained from at least one fungal strain selected from Basidiomycota, Ascomycota, Pezizomycotina, Agaromycotina, Pezizomycetes, Agaricomycetes, Sordariomycetes, Pezizales, Boletales, Cantharellales, Agaricales, Polyporales, Russulales, Auriculariales, Hypocreales, Morchellaceae, Tuberaceae, Pleurotaceae, Agaricaceae, Marasmiaceae, Cantharellaceae, Hydnaceae, Boletaceae, Meripilaceae, Polyporaceae, Strophariaceae, Lyophyllaceae, Tricholomataceae, Omphalotaceae, Physalacriaceae, Schizophyllaceae, Sclerodermataceae, Ganodermataceae, Sparassidaceae, Hericiaceae, Bondarzewiaceae, Cordycipitaceae, Auriculariaceae, and Fistulinacea.

More preferably, the edible fibrous mycelium mass is obtained from at least one fungal strain selected from Basidiomycota, Ascomycota, Pezizomycotina, Agaromycotina, Agaricomycetes, Pezizales, Boletales, Cantharellales, Agaricales, Polyporales, Russulales, Auriculariales, Hypocreales, Morchellaceae, Tuberaceae, Pleurotaceae, Agaricaceae, Marasmiaceae, Cantharellaceae, Hydnaceae, Boletaceae, Meripilaceae, Polyporaceae, Strophariaceae, Lyophyllaceae, Tricholomataceae, Omphalotaceae, Physalacriaceae, Schizophyllaceae, Sclerodermataceae, Ganodermataceae, Sparassidaceae, Hericiaceae, Bondarzewiaceae, Cordycipitaceae, Auriculariaceae, and Fistulinacea.

Even more preferably, the mycelium mass is obtained from Pleurotus pulmonarius, Pleurotus ostreatus, Pleurotus florida, Pleurotus citrinopileatus, Pleurotus saimoneostramineus, Morchella esculenta, Morchella angusticeps, or Morchella deliciosa.

Even more preferably, the mycelium mass is obtained from Pleurotus pulmonarius, Pleurotus florida, Pleurotus citrinopileatus, Pleurotus salmoneostramineus, Morchella esculenta, Morchella angusticeps, or Morchella deliciosa

Most preferably, the mycelium mass is obtained from Pleurotus pulmonarius or Morchella rufobrunnea.

In one preferred embodiment, the mycelium mass is obtained from Pleurotus pulmonarius. In another preferred embodiment, the mycelium mass is obtained from or Morchella rufobrunnea. In one preferred embodiment, the mycelium biomass comprises Pleurotus pulmonarius and Morchella rufobrunnea.

### Methods of Producing Edible Non-Animal Dairy Substitute Product of the Present Invention

The present invention is also concerned with methods of producing the edible non-animal dairy substitute product of the present invention.

In one embodiment, the method of producing an edible non-animal dairy substitute product comprises

a) homogenizing an edible fibrous mycelium mass with water, thereby obtaining an edible non-animal milk substitute product. Preferably, the edible fibrous mycelium mass is derived from submerged fermentation.

The mycelium mass can be used directly after fermentation or after adjusting the water content by pressing or (partial) drying. “Homogenizing the mycelium mass with water” means that the water component of the mycelium mass and the solid components are mixed to obtain a homogenous mass. The water component can be provided by the mycelium itself, for example if it is a wet mycelium, and/or it can (further) comprise water added externally as necessary to obtain a water content similar to the water content of the dairy product to be substituted or to the water content of the raw material used in the process of making the respective dairy product.

In another embodiment, the method of producing an edible non-animal dairy substitute product comprises
a) homogenizing an edible fibrous mycelium mass with water,
b) heating the homogenized mixture to 25 to 95° C., preferably to 50° C.;
c) optionally adding a texturizing agent, such as agar-agar, edible starch, guar gum, locust bean gum, wheat gluten, cellulose or derivatives of it to the heated homogenized mixture of step b) and stirring the obtained mixture;
d) letting the mixture cool down to 20° C. to 45° C.;
e) adding acid-forming bacteria such as lactic acid bacteria culture or enzymes with protein-digesting properties, and
f) mixing the mixture obtained after step e), thereby obtaining an edible non-animal yoghurt substitute product.

Preferably, the edible fibrous mycelium mass is derived from submerged fermentation.

Adding a texturizing agent is an optional step depending on the water content of the homogenized mycelium mass obtained in step a). If the water content is similar to the water content of the substitute product to be produced, then adding a texturizing agent is not necessary to obtain the texture.

In another embodiment, the method of producing an edible non-animal dairy substitute product comprises
a) homogenizing an edible fibrous mycelium mass with water,
b) heating the homogenized mixture to 25 to 95° C., preferably to 50° C.; c) adding an edible plant, algae or fungi-based fat component in the range of up to 60 wt %, preferably up to 25 wt %, and most preferably from 1 wt % to 5 wt %;
d) homogenizing the mixture obtained after step c);
g) letting the mixture cool down to 20° C. to 45° C., preferably to 25° C. to 45° C., most preferably to 32° C. to 37° C.;
h) adding acid-forming bacteria in particular lactic acid bacteria culture or enzymes with protein-digesting properties; and
i) mixing the mixture obtained; thereby obtaining an edible non-animal cheese substitute product, preferably after storing for 1-48 h at 1-37° C.

In a preferred embodiment, the product obtained with this method is an edible non-animal fresh cheese substitute product. It can also be an edible non-animal cheese substitute product selected from the group comprising an edible non-animal substitute product for whey cheese, cream cheese, medium-hard cheese, hard-cheese, and soft-mould cheese, which can be obtained without traditional coagulation steps if the water content of the homogenized mycelium mass is suitably adjusted to be sufficiently low. The coagulation steps of traditional cheese making are done to get rid of the excess water provided by the starting material, which is milk. By having a starting material, i.e. the homogenized mycelium mass, which has a significantly lower water content compared to milk, these coagulation steps of traditional cheese making are not necessary.

Preferably, the edible fibrous mycelium mass is derived from submerged fermentation.

In another embodiment the method of producing an edible non-animal dairy substitute product comprises
a) homogenizing an edible fibrous mycelium mass with water,
b) heating the homogenized mixture to 25 to 95° C., preferably to 50° C.;
c) adding an edible plant, algae or fungi-based fat component in the range of up to 60 wt %, preferably up to 25 wt %, and most preferably from 1 wt % to 5 wt %;
d) homogenizing the mixture obtained after step c);
f) letting the mixture cool down to 20° C. to 45° C., preferably to 25° C. to 45° C., most preferably to 32° C. to 37° C.;
g) adding acid-forming bacteria in particular lactic acid bacteria culture or enzymes with protein-digesting properties;
h) mixing the mixture obtained after step g);
i) coagulating the mixture obtained after step h) by adding a coagulating agent to obtain a mixture of coagulated solids and liquids;
j) allowing the mixture obtained after step i) to settle;
k) separating the coagulated solids from the liquids; and
l) storing the coagulated solids,
thereby obtaining an edible non-animal cheese substitute product selected from the group comprising an edible non-animal substitute product for whey cheese, cream cheese, medium-hard cheese, hard-cheese, and soft-mould cheese.

Preferably, the edible fibrous mycelium mass is derived from submerged fermentation.

The method of producing an edible non-animal fresh cheese or cheese substitute product can further comprise, prior to letting the mixture cool down, step e) adding a plant-based emulsifier, such as lecithin, mono- and diglycerides, glycerides, monoglyceride derivatives, or fatty acid derivatives. It is an advantage provided by the inventive mycelium mass and the production methods of the present invention that addition of calcium chloride or other mineral salts, such as calcium acetate to the mixture is not necessary to reach a calcium content desired for a dairy substitute product, as the mycelium mass itself already provides the necessary amounts of calcium.

In the method of producing an edible non-animal dairy substitute product for whey cheese, cream cheese, medium-hard cheese, hard-cheese, and soft-mould cheese, the coagulating agent preferably is a composition comprising a mineral or organic acid, such as lemon juice, or a non-animal based rennet comprising a mixture of enzymes derived from plants, bacteria or yeast.

In the method of producing an edible non-animal dairy substitute product for fresh cheese, whey cheese, cream cheese, medium-hard cheese, hard-cheese, and soft-mould cheese, the edible plant-based fat component is preferably selected from coconut oil, sunflower oil, rapeseed oil, palm oil, cotton seed oil, olive oil, canola oil, algae oil, or oleaginous yeast-derived oils.

The present invention is also concerned with the use of an edible fibrous mycelium mass for producing an edible non-animal dairy substitute product, wherein the edible non-animal dairy substitute product is selected from products substituting milk, yoghurt, fresh cheese, whey cheese, cream cheese, medium-hard cheese, hard-cheese, and soft-mould cheese.

The edible non-animal dairy substitute products of the present invention and the methods of producing the edible non-animal dairy substitute products of the present invention will now be further illustrated by the following examples.

### EXAMPLES

### Example 1—Analytical methods

The products of the present invention were analyzed with respect to their compositions. Standard analytical methods were used to determine the contents of the compositions.

Protein content was determined according to DIN EN ISO 16634-1, 2009-07, (N*6.25) DUMAS.

Fat content was determined according to Weibull-Stoldt.

Fiber content was determined according to enzymatic-gravimetric method ASU L 00.00-18.

Carbohydrate content was determined via HPLC according to SOP M 2569.

The calorific value was calculated as known in the art.

The contents of calcium, magnesium, iron, zinc, manganese, and phosphorus were determined via Inductively Coupled Plasma Mass Spectrometry (ICP-MS) according to standard operating procedures.

The contents of vitamin B1, B2, and B6 were determined via HPLCE/FL according to DIN EN 14122.

The content of vitamin B3 (niacin) was determined microbiologically according to AOAC 944.13.

The content of vitamin B5 (pantothenic acid) was determined microbiologically according to AOAC 945.74.

The content of vitamin B7 (biotin) was determined microbiologically according to SOP m 655 (L. plantarium).

The content of vitamin B9 (folic acid) was determined according to DIN EN 14131:2003.

The contents of the amino acids alanine, asparagine, aspartate, cysteine+cystine, glutamate, glycine, histidine, isoleucine, leucine, lysine, methionine, phenylalanine, proline, serine, threonine, valine, tryptophan, tyrosine, and ornithine were determined via LC-MS/MS according to SOP M 3123.

### Example 2—Edible Mycelium Mass

Two batches of mycelium mass and water were prepared as basis for the production of the edible non-animal dairy substitute products as follows.

Mycelium grown in submerged fermentation is harvested by filtration over a cheese cloth (MilkyWay) yielding 642 g (batch 1) and 550 g (batch 2). After draining the supernatant mechanically by pressure the filter cake containing the mycelium is washed with tap water at a volume of 2 to 3 times the volume of the removed supernatant, and pressed again. This procedure is repeated twice.

For the application examples, the mycelium is used directly after pressing.

For the analysis of each batch 1 and batch 2 200 g of mycelium are frozen at −80° C. and dried using a freeze-dryer of company Zirbus technology GmbH (Bad Grund) for the chemical analysis.

Batch 1

After pressing, batch 1 had a dry matter content of 6.09%.

After freeze-drying, batch 1 contained 92.85% dry mass of the mycelium and 7.15% water.

Batch 1 had the following composition based on 100% dry mass:

TABLE 1

| | | |
|---|---|---|
| Protein | 21.86 | g/100 g dry product |
| Fat | 3.12 | g/100 g dry product |
| Ash | 7.04 | g/100 g dry product |
| Carbohydrates | | |
| Total Fibers | 63.27 | g/100 g dry product |
| Soluble | 3.50 | g/100 g dry product |
| Insoluble | 59.77 | g/100 g dry product |
| Sugar | 4.70 | g/100 g dry product |
| Calorific value | 260.64 | kcal/100 g dry product |
| | 1073.77 | KJ/100 g dry product |
| Vitamin B1 | 135.86 | μg/100 g dry product |
| Vitamin B2 | 4407.80 | μg/100 g dry product |
| Vitamin B6 | 234.39 | μg/100 g dry product |
| Vitamin B3 (Niacin) | 19601.74 | μg/100 g dry product |
| Vitamine B5 (Pantothenic acid) | 5310.10 | μg/100 g dry product |
| Vitamin B8 (Biotin) | 16.39 | μg/100 g dry product |
| Vitamin B9 (Folic acid) | 487.45 | μg/100 g dry product |
| Vitamin B12 | nd | μg/100 g dry product |
| Calcium | 378.14 | mg/100 g dry Product |
| Magnesium | 150.35 | mg/100 g dry product |
| Iron | 74.21 | mg/100 g dry product |
| Zinc | 68.93 | mg/100 g dry product |
| Manganese | 2.37 | mg/100 g dry product |

Batch 2

After pressing, batch 2 had a dry matter content of 9.89%.

After freeze-drying, batch 2 contained 95.60% dry mass of the mycelium and 4.4% water.

Batch 2 had the following composition calculated to 100% dry mass:

TABLE 2

| | | |
|---|---|---|
| Protein | 37.66 | g/100 g dry product |
| Fat | 3.14 | g/100 g dry product |
| Ash | 9.28 | g/100 g dry product |
| Carbohydrates | | |
| Total Fibers | 44.05 | g/100 g dry product |
| Soluble | 4.82 | g/100 g dry product |
| Insoluble | 39.23 | g/100 g dry product |
| Sugar | 5.88 | g/100 g dry product |
| Calorific value | 290.80 | kcal/100 g dry product |
| | 1208.16 | KJ/100 g dry product |
| Calcium | 1331.59 | mg/100 g dry Product |
| Magnesium | 177.51 | mg/100 g dry product |
| Iron | 22.80 | mg/100 g dry product |
| Zinc | 24.37 | mg/100 g dry product |
| Manganese | 2.82 | mg/100 g dry product |
| Phosphorus | 2131.799 | mg/100 g dry product |

The amino acid content of batch 2 had the following composition.

TABLE 3

| Amino acid | g/100 g | % of total protein |
|---|---|---|
| Alanin | 2.33 | 7.40% |
| Asparagine | 2.62 | 8.32% |
| Aspartate | 2.83 | 8.99% |
| Cystein + Cystine | 0.544 | 1.73% |
| Glutamate | 5.5 | 17.47% |
| Glycine | 1.53 | 4.86% |
| Histidine | 0.914 | 2.90% |
| Isoleucine | 1.34 | 4.26% |
| Leucine | 2.42 | 7.69% |
| Lysine | 1.86 | 5.91% |
| Methionine | 0.446 | 1.42% |
| Phenylalanine | 1.29 | 4.10% |
| Proline | 2.08 | 6.61% |
| Serine | 1.64 | 5.21% |
| Threonine | 1.56 | 4.95% |
| Valine | 1.65 | 5.24% |
| Tryptophan | 0.442 | 1.40% |
| Tyrosine | 0.963 | 3.06% |

The relatively high amount of glutamate in the mycelium can provide the umami flavor to the edible non-animal dairy substitute products.

### Example 3—Edible Non-Animal Milk Substitute Product

An edible non-animal milk substitute product was produced using edible mycelium mass of batch 2 after pressing (see above).

95 g of an edible fibrous mycelium mass was homogenized with 20 ml of water in a kitchen blender. An edible non-animal milk substitute product was obtained. The liquid has a white opalescent colour, neutral taste and pleasant fruity odour.

The contents of the edible non-animal milk substitute product are listed in the following table 4.

TABLE 4

| | | | | |
|---|---|---|---|---|
| Protein | 3.08 | g/100 g | 4.8% | daily intake (80 kg adult) |
| Fat | 0.26 | g/100 g | 0.4% | daily intake (80 kg adult) |
| Fibers | 3.60 | g/100 g | 9.5% | daily intake (80 kg adult) |
| Carbohy- | 3.07 | g/100 g | 0.9% | daily intake (80 kg adult) |
| drates | | | | |
| Calorific | 23.76 | kcal/100 g | 0.7% | daily intake (80 kg adult) |
| value | | | | |
| Calcium | 108.79 | mg/100 g | 10.9% | daily intake (80 kg adult) |
| Magnesium | 14.50 | mg/100 g | 3.6% | daily intake (80 kg adult) |
| Iron | 1.86 | mg/100 g | 23.3% | daily intake (80 kg adult) |
| Zinc | 1.99 | mg/100 g | 18.1% | daily intake (80 kg adult) |
| Manganese | 0.23 | mg/100 g | 10.0% | daily intake (80 kg adult) |
| Phosphorus | 174.2 | mg/100 g | 25.1% | daily intake (80 kg adult) |
| β-glucan | 1879.1 | mg/100 g | 63% | daily intake (80 kg adult) |
| Vitamin B1 | 9.74 | μg/100 g | 0.98% | daily intake (80 kg adult) |
| Vitamin B2 | 255.32 | μg/100 g | 13.85% | daily intake (80 kg adult) |
| Vitamin B6 | 14.06 | μg/100 g | 1.31% | daily intake (80 kg adult) |
| Vitamin B3 | 1407.45 | μg/100 g | 9.88% | daily intake (80 kg adult) |
| (niacin) | | | | |
| Vitamin B5 | 362.68 | μg/100 g | 8.94% | daily intake (80 kg adult) |
| (pantothenic | | | | |
| acid) | | | | |
| Vitamin B7 | 0.88 | μg/100 g | 3.55% | daily intake (80 kg adult) |
| (biotin) | | | | |
| Vitamin B9 | 38.04 | μg/100 g | 10.63% | daily intake (80 kg adult) |
| (folic acid) | | | | |

### Example 4—Edible Non-Animal Yoghurt Substitute Product

95 g of mycelium mass from batch 2 was homogenized in a kitchen blender with 200 ml of water. After heating to 95° C. it is mixed with 5 g of Agar-Agar (Agartine, Ruf GmbH) and 10 g sugar and stirred continuously for 2 min. After cooling down to 45° C. 0.2 g of lactic acid bacteria culture (MilkySky GmbH) is mixed under stirring. At room temperature, the liquid is put into jars and left at 4° C. for 48 hours.

The product has a white-cream colour with a smooth surface. It has a neutral, slightly acidic taste with no off-flavours and a pleasant acidic odour.

The contents of the edible non-dairy yoghurt substitute product contributed by the mycelium are listed in the following table 5.

TABLE 5

| | | | | |
|---|---|---|---|---|
| Protein | 1.1 | g/100 g | 1.8% | daily intake (80 kg adult) |
| Fat | 0.1 | g/100 g | 0.1% | daily intake (80 kg adult) |
| Fibers | 1.3 | g/100 g | 3.5% | daily intake (80 kg adult) |
| Carbohydrates | 2.8 | g/100 g | 0.8% | daily intake (80 kg adult) |
| Calorific value | 8.8 | kcal/100 g | 0.3% | daily intake (80 kg adult) |
| Calcium | 40.4 | mg/100 g | 4.0% | daily intake (80 kg adult) |
| Magnesium | 5.4 | mg/100 g | 1.3% | daily intake (80 kg adult) |
| Iron | 0.7 | mg/100 g | 8.6% | daily intake (80 kg adult) |
| Zinc | 0.7 | mg/100 g | 6.7% | daily intake (80 kg adult) |
| Manganese | 0.1 | mg/100 g | 3.7% | daily intake (80 kg adult) |
| Phosphorus | 65.2 | mg/100 g | 9.2% | daily intake (80 kg adult) |

### Example 5—Edible Non-Animal Cheddar Type Cheese Substitute Product

Cheddar type cheese was produced comprising mycelium mass as protein component alone with edible fats like coconut or sunflower with a texturizing agent.

95 g of mycelium mass from batch 2 were homogenized in a kitchen blender with 25 g of water. To this 20 g of native coconut oil (Rapunzel GmbH), 2 tablespoons of red pepper powder (Metro AG), 2 g of salt and 0.3 g of black pepper are added and mixed again.

10g of Agar-Agar (Agartine, Ruf GmbH) are mixed into 100 ml of water and heated to boiling and stirred continuously for 2 min. The liquid is then added to the kitchen blender, mixed for 45 seconds and poured into a forming vessel. It is left there for cooling to room temperature for 2 hours. Hardening process is continued at 7° C. for another 12 hours.

A sliceable cheddar-type cheese is obtained with a slightly spicy, umami flavour and a good mouthfeel.

The contents of the edible non-dairy cheddar cheese substitute product derived from the mycelium are listed in the following table 6.

TABLE 6

| | | | | |
|---|---|---|---|---|
| Protein | 1.4 | g/100 g | 2.2% | daily intake (80 kg adult) |
| Fat | 0.1 | g/100 g | 0.2% | daily intake (80 kg adult) |
| Fibers | 1.6 | g/100 g | 4.3% | daily intake (80 kg adult) |
| Carbohydrates | 2.8 | g/100 g | 0.8% | daily intake (80 kg adult) |
| Calorific value | 10.8 | kcal/100 g | 0.3% | daily intake (80 kg adult) |
| Calcium | 49.5 | mg/100 g | 4.9% | daily intake (80 kg adult) |
| Magnesium | 6.6 | mg/100 g | 1.6% | daily intake (80 kg adult) |
| Iron | 0.8 | mg/100 g | 10.6% | daily intake (80 kg adult) |
| Zinc | 0.9 | mg/100 g | 8.2% | daily intake (80 kg adult) |
| Manganese | 0.1 | mg/100 g | 4.6% | daily intake (80 kg adult) |
| Phosphorus | 79.3 | mg/100 g | 11.4% | daily intake (80 kg adult) |

### Example 6—Edible Non-Animal Fresh Type Cheese Substitute Product

Five different samples were prepared either from cashew nuts as a reference sample or from mycelium of Pleurotus pulmonarius.

1. Cashew nuts

40 g of cashew nuts were watered for 10 hours, water was removed and 0.3 g of salt added. 10 ml of water was added back and a smooth material created by subjecting to 2 min of mincing with a standard mixer.

2. Mycelium of Pleurotus pulmonarius

80 g of mycelium of batch 2 were homogenized as described in patent GB2137226A with 20 g of added water
A: Reference sample: To 25 g of the cashew nut mix from 1. ½ teaspoon of vegan lactic acid bacteria culture (Rejuvelac—enzymes on the basis of cereals) was added and stirred for 1 min.
B: To 25 g of the above cashew nut mix from 1. % teaspoon of vegan lactic acid bacteria culture (Rejuvelac equivalent, MilkySky GmbH) and 25 g of homogenized mycelium from 2. were added and the whole mix stirred for 1 min.
C: To 25 g of the homogenized mycelium from 2. ½ teaspoon of vegan lactic acid bacteria culture (Rejuvelac equivalent, MilkySky GmbH) were added and the whole mix stirred for 1 min.
D: To 25 g of the homogenized mycelium from 2. 0.3 g of ME vegan lactic acid bacteria culture (MilkySky GmbH) were added and the whole mix stirred for 45 min. at 32° C.
E: To 25 g of the homogenized mycelium from 2. 0.3 g of ME vegan lactic acid bacteria culture (MilkySky GmbH) and 5 g of coconut oil were added and the whole mix stirred for 45 min. at 32° C.

Samples were left standing at 7° C. for 12 hours and then tasted.
A: Nut-like, yeasty taste—no fresh cheese impression
B: Less yeasty taste than A, slightly acidic taste—lack of a strong note
C: Stronger acidic taste, yeasty note less present than B—good mouthfeel, but lack of body
D: Very acidic taste with dairy note, no yeast note—more like fresh cheese from cow milk than A-C
E: Less acidic and more rounded dairy taste than D—best rated sample to mimic fresh cheese taste

The contents of the edible non-dairy fresh type cheese substitute product according to Sample C-E from the mycelium are listed in the following table 7.

TABLE 7

| | | | | |
|---|---|---|---|---|
| Protein | 3.0 | g/100 g | 4.7% | daily intake (80 kg adult) |
| Fat | 0.2 | g/100 g | 0.3% | daily intake (80 kg adult) |
| Fibers | 3.5 | g/100 g | 9.2% | daily intake (80 kg adult) |
| Carbohydrates | 3.1 | g/100 g | 0.9% | daily intake (80 kg adult) |
| Calorific value | 23.0 | kcal/100 g | 0.7% | daily intake (80 kg adult) |
| Calcium | 105.4 | mg/100 g | 10.5% | daily intake (80 kg adult) |
| Magnesium | 14.0 | mg/100 g | 3.5% | daily intake (80 kg adult) |
| Iron | 1.8 | mg/100 g | 22.6% | daily intake (80 kg adult) |
| Zinc | 1.9 | mg/100 g | 17.5% | daily intake (80 kg adult) |
| Manganese | 0.2 | mg/100 g | 9.7% | daily intake (80 kg adult) |
| Phosphorus | 169.1 | mg/100 g | 24.2% | daily intake (80 kg adult) |

### Example 7—Production of a Homogeneous Aqueous Solution of Mycelia for Cheese Production, Followed by Traditional Cheese Processing to Obtain Edible Substitute Products for Whey Cheese, Cream Cheese, Medium-Hard Cheese, Hard-Cheese, and Cheddar

100 g of mycelium of batch 2 are homogenized with 200 ml of water. This mixture is warmed to 50° C. and 15 g of coconut oil (Rapunzel) and one drop of lecithin (Cosmothek GmbH, Germany) added and homogeneously mixed. Heating is stopped and when the mixture reaches 37° C. 0.2 g ME vegan lactic acid bacteria culture (MilkySky GmbH) is added and mixed well.
A: In one variation 30 ml lemon juice are added, stirred softly into the mix to co-agulate the “milk”.
B: In another variation, 25 droplets of a vegetarian commercial rennet (MilkySky GmbH) are added and stirred into the mix.

In both variations, the mix is removed from the heat and not moved for 3 hours. Subsequently the resulting mix is cut with a knife in squares of 0.5×1 cm and left settling for another 30 min. After careful stirring for another 30 min, the coagulated solids are transferred carefully to a cheese cloth put into a beaker with holes. After 20 min, when the liquids stop draining from the beaker, gentle pressure is exerted. After standing for 10 min, this is repeated once more. After that, a whey cheese substitute similar in appearance to Ricotta is stored at 7° C. for 3 hours.

The edible non-animal cheese substitute product has a granular structure, which can be cut, and a bland dairy-like taste.

The contents of the edible non-dairy coagulated Ricotta like substitute product are listed in the following table 8.

TABLE 8

| | | | | |
|---|---|---|---|---|
| Protein | 3.2 | g/100 g | 5.1% | daily intake (80 kg adult) |
| Fat | 0.3 | g/100 g | 0.4% | daily intake (80 kg adult) |
| Fibers | 3.8 | g/100 g | 10.0% | daily intake (80 kg adult) |
| Carbohydrates | 3.1 | g/100 g | 0.9% | daily intake (80 kg adult) |
| Calorific value | 25.0 | kcal/100 g | 0.8% | daily intake (80 kg adult) |
| Calcium | 114.5 | mg/100 g | 11.5% | daily intake (80 kg adult) |
| Magnesium | 15.3 | mg/100 g | 3.8% | daily intake (80 kg adult) |
| Iron | 2.0 | mg/100 g | 24.5% | daily intake (80 kg adult) |
| Zinc | 2.1 | mg/100 g | 19.1% | daily intake (80 kg adult) |
| Manganese | 0.2 | mg/100 g | 10.6% | daily intake (80 kg adult) |
| Phosphorus | 183.3 | mg/100 g | 26.2% | daily intake (80 kg adult) |

### Example 8—Production of a Homogeneous Aqueous Solution of Mycelia for Cheese Production, Followed by Traditional Cheese Processing to Obtain Edible Substitute Products for Whey Cheese, Cream Cheese, Medium-Hard Cheese, Hard-Cheese, and Cheddar

68 g of mycelium of Pleurotus pulmonarius from batch 1 are homogenized in a thermomixer with 210 ml of water, 10.2 g of coconut oil and 1 g of lecithin for 25 min at maximum speed.

To the homogenous mixture 0.05 g TME culture vegan (MilkySky GmbH) and 0.05 g of Penicillium candidum is added and left for 12 h at 4° C. Afterwards the mixture is heated to 35° C. and 0.05 g vegan lactic acid bacteria are added and the mix is kept at 35° C. for 60 min. Vegetarian rennet with 0.2 ml (MilkySky GmbH) dissolved in 5 ml water is added. After coagulation and cooling down to 20° C. and leaving for another 90 min, the curd is separated from the whey via a cheese cloth and pressed gently with the plastic lid. After 2 hours and several times flipping the curd block over only little whey drops out.

The pre-formed cheese is left for another 12 hours at 4° C. and then gently salted with 1 g salt on all sides. After that it is bedded on a plastic mat and stored for maturing in a cultivation box (MilkySky GmbH) at 18° C. for 12 days. Every two days the cheese is flipped over.

After maturation, the cheese has a light white mold cover and a creamy structure similar to milk-derived camembert with a good mouthfeel.

The contents of the edible non-dairy coagulated Camembert cheese substitute product (middle-hard cheese) coming from the mycelium are listed in the following table 9.

TABLE 9

| | | | | |
|---|---|---|---|---|
| Protein | 1.1 | g/100 g | 1.8% | daily intake (80 kg adult) |
| Fat | 0.2 | g/100 g | 0.2% | daily intake (80 kg adult) |
| Fibers | 3.3 | g/100 g | 8.7% | daily intake (80 kg adult) |
| Carbohydrates | 0.7 | g/100 g | 0.2% | daily intake (80 kg adult) |
| Calorific value | 13.7 | kcal/100 g | 0.4% | daily intake (80 kg adult) |
| Calcium | 19.8 | mg/100 g | 2.0% | daily intake (80 kg adult) |
| Magnesium | 7.9 | mg/100 g | 2.0% | daily intake (80 kg adult) |
| Iron | 3.9 | mg/100 g | 48.6% | daily intake (80 kg adult) |
| Zinc | 3.6 | mg/100 g | 32.8% | daily intake (80 kg adult) |
| Manganese | 0.1 | mg/100 g | 5.4% | daily intake (80 kg adult) |

Further examples and/or embodiments of the present invention are disclosed in the following numbered items.

1. An edible non-animal dairy substitute product, comprising
a) an edible fibrous mycelium mass in the range of 1 wt % to 99 wt %, and
b) water in the range of up to 99 wt %

2. The edible non-animal dairy substitute product of item 1, wherein the edible fibrous mycelium mass is derived from submerged fermentation.

3. The edible non-animal dairy substitute product of item 1 or 2, wherein the fibrous mycelium mass has a protein content of between 10 wt % and 60 wt %, preferably between 20 wt % and 50 wt %, and most preferably between 25 wt % and 35 wt % of a dry mass of the fibrous mycelium mass.

4. The edible non-animal dairy substitute product of any one of items 1 to 3, comprising the fibrous mycelium mass in the range of 20 wt % to 95 wt %, preferably in the range of 65 wt % to 90 wt %, and/or wherein the phosphorus content of the edible non-animal dairy substitute product is from 40 to 500 mg per 100 g weight of the edible non-animal dairy substitute product, preferably from 60 to 250 mg per 100 g weight of the edible non-animal dairy substitute product, and/or wherein the calcium content of the edible non-animal dairy substitute product is from 25 to 400 mg per 100 g weight of the edible non-animal dairy substitute product, preferably from 40 to 250 mg per 100 g weight of the edible non-animal dairy substitute product, and/or wherein the zinc content of the edible non-animal dairy substitute product is from 0.5 to 5 mg per 100 g weight of the edible non-animal dairy substitute product, preferably from 0.3 to 4 mg per 100 g weight of the edible non-animal dairy substitute product.

5. The edible non-animal dairy substitute product of any one of items 1 to 4, further comprising a texturizing agent, such as agar-agar, edible starch, guar gum, locust bean gum, wheat gluten, cellulose or derivatives of it, colorants and/or a flavorant, such as salt, extracts and/or spices.

6. The edible non-animal dairy substitute product of any one of items 1 to 5, further comprising an edible plant-, or algae-based fat component, a fat component derived from fungi or yeast, in the range of up to 60 wt %, preferably up to 25 wt %, and most preferably from 1 wt % to 5 wt %.

7. The edible non-animal dairy substitute product of item 6, wherein the edible plant-based fat component is selected from coconut oil, sunflower oil, rapeseed oil, palm oil, cotton seed oil, olive oil, canola oil, algae oil, or oleaginous yeast-derived oils.

8. The edible non-animal dairy substitute product of any one of items 1 to 7, wherein the edible non-animal dairy substitute product is selected from products substituting milk, yoghurt, fresh cheese, whey cheese, cream cheese, medium-hard cheese, hard-cheese, and soft-mould cheese.

9. Method of producing an edible non-animal dairy substitute product, the method comprising
a) homogenizing an edible fibrous mycelium mass with water, wherein optionally the edible fibrous mycelium mass is derived from submerged fermentation;
thereby obtaining an edible non-animal milk substitute product.

10. Method of item 9, the method further comprising
b) heating the homogenized mixture to 25 to 95° C., preferably to 50° C.;
c) optionally adding a texturizing agent, such as agar-agar, edible starch, guar gum, locust bean gum, wheat gluten, cellulose or derivatives of it to the heated homogenized mixture of step b) and stirring the obtained mixture;
d) letting the mixture cool down to 20° C. to 45° C.;
e) adding acid-forming bacteria such as lactic acid bacteria culture or enzymes with protein-digesting properties;
f) mixing the mixture obtained after step e);
thereby obtaining an edible non-animal yoghurt substitute product.

11. Method of item 9, further comprising:
b) heating the homogenized mixture to 25 to 95° C., preferably to 50° C.;
c) adding an edible plant, algae or fungi-based fat component in the range of up to 60 wt %, preferably up to 25 wt %, and most preferably from 1 wt % to 5 wt %;
d) homogenizing the mixture obtained after step c);
e) optionally adding a plant-based emulsifier such as lecithin, mono- and diglycerides, glycerides, monoglyceride derivatives, or fatty acid derivatives;
f) letting the mixture cool down to 20° C. to 45° C., preferably to 25° C. to 45° C., most preferably to 32° C. to 37° C.;
g) adding acid-forming bacteria in particular lactic acid bacteria culture or enzymes with protein-digesting properties;
h) mixing the mixture obtained after step g);
thereby obtaining an edible non-animal cheese substitute product, such as a fresh cheese substitute product, preferably after storing for 1-48 h at 1-37° C.

12. Method of item 11, further comprising:
i) coagulating the mixture obtained after step h) of claim 11 by adding a coagulating agent to obtain a mixture of coagulated solids and liquids;
j) allowing the mixture obtained after step i) to settle;
k) separating the coagulated solids from the liquids;
l) storing the coagulated solids,
thereby obtaining an edible non-animal cheese substitute product selected from the group comprising an edible non-animal substitute product for whey cheese, cream cheese, medium-hard cheese, hard-cheese, and soft-mould cheese.

13. The method of item 12, wherein the coagulating agent is a composition comprising a mineral or organic acid, such as lemon juice, or a non-animal based rennet comprising a mixture of enzymes derived from plants, bacteria or yeast.

14. The method of any one of item 11 to 13, wherein the edible plant-based fat component is selected from coconut oil, sunflower oil, rapeseed oil, palm oil, cotton seed oil, olive oil, canola oil, algae oil, or oleaginous yeast-derived oils.

15. Use of an edible fibrous mycelium mass for producing an edible non-animal dairy substitute product, wherein the edible non-animal dairy substitute product is selected from products substituting milk, yoghurt, fresh cheese, whey cheese, cream cheese, medium-hard cheese, hard-cheese, and soft-mould cheese.

16. The edible non-animal dairy substitute product of any one of items 1 to 8, or the method of any one of items 9 to 14, or the use of item 15, wherein the edible fibrous mycelium mass is obtained from at least one fungal strain selected from Basidiomycota, Ascomycota, Pezizomycotina, Agaromycotina, Pezizomycetes, Agaricomycetes, Sordariomycetes, Pezizales, Boletales, Cantharellales, Agaricales, Polyporales, Russulales, Auriculariales, Hypocreales, Morchellaceae, Tuberaceae, Pleurotaceae, Agaricaceae, Marasmiaceae, Cantharellaceae, Hydnaceae, Boletaceae, Meripilaceae, Polyporaceae, Strophariaceae, Lyophyllaceae, Tricholomataceae, Omphalotaceae, Physalacriaceae, Schizophyllaceae, Sclerodermataceae, Ganodermataceae, Sparassidaceae, Hericiaceae, Bondarzewiaceae, Cordycipitaceae, Auriculariaceae, and Fistulinacea, wherein preferably the mycelium mass is obtained from Pleurotus pulmonarius, Pleurotus ostreatus, Pleurotus florida, Pleurotus citrinopileatus, Pleurotus salmoneostramineus, Morchella esculenta, Morchella angusticeps, or Morchella deliciosa mycelium mass.

1. An edible non-animal dairy substitute product, comprising
a) an edible fibrous mycelium mass in the range of 1 wt % to 99 wt %, and
b) water in the range of up to 99 wt %,
wherein the edible fibrous mycelium has an insoluble fiber content of at least 39% w/w.

2. The edible non-animal dairy substitute product of claim 1, wherein the edible fibrous mycelium mass is derived from submerged fermentation.

3. The edible non-animal dairy substitute product of claim 1 or 2, wherein the fibrous mycelium mass has a protein content of between 10 wt % and 60 wt %,

4. The edible non-animal dairy substitute product of claim 3, wherein the fibrous mycelium mass has a protein content of between 20 wt % and 50 wt % of a dry mass of the fibrous mycelium mass.

5. The edible non-animal dairy substitute product of claim 3, wherein the fibrous mycelium mass has a protein content of between 25 wt % and 35 wt % of a dry mass of the fibrous mycelium mass.

6. The edible non-animal dairy substitute product of any one of claims 1 to 5, comprising the fibrous mycelium mass in the range of 20 wt % to 95 wt %.

7. The edible non-animal dairy substitute product of claim 6, comprising the fibrous mycelium mass in the range of 65 wt % to 90 wt %.

8. The edible non-animal dairy substitute product of any one of claim 6, comprising the fibrous mycelium mass in the range of 1 wt % to 35 wt %.

9. The edible non-animal dairy substitute product of any one of claims 1 to 8, wherein the phosphorus content of the edible non-animal dairy substitute product is from 40 to 500 mg per 100 g weight of the edible non-animal dairy substitute product.

10. The edible non-animal dairy substitute product of claim 9, wherein the phosphorus content of the edible non-animal dairy substitute product is from 60 to 250 mg per 100 g weight of the edible non-animal dairy substitute product.

11. The edible non-animal dairy substitute product of any one of claims 1 to 10, wherein the calcium content of the edible non-animal dairy substitute product is from 20 to 400 mg per 100 g weight of the edible non-animal dairy substitute product.

12. The edible non-animal dairy substitute product of claim 11, wherein the calcium content of the edible non-animal dairy substitute product is from 25 to 400 mg per 100 g weight of the edible non-animal dairy substitute product.

13. The edible non-animal dairy substitute product of claim 12, wherein the calcium content of the edible non-animal dairy substitute product is from 40 to 250 mg per 100 g weight of the edible non-animal dairy substitute product.

14. The edible non-animal dairy substitute product of any one of claims 1 to 13, wherein the zinc content of the edible non-animal dairy substitute product is from 0.5 to 5 mg per 100 g weight of the edible non-animal dairy substitute product.

15. The edible non-animal dairy substitute product of claim 14, wherein the zinc content of the edible non-animal dairy substitute product is from 0.3 to 4 mg per 100 g weight of the edible non-animal dairy substitute product.

16. The edible non-animal dairy substitute product of any one of claims 1 to 15, further comprising a texturizing agent, such as agar-agar, edible starch, guar gum, locust bean gum, wheat gluten, cellulose or derivatives of it, colorants and/or a flavorant, such as salt, extracts and/or spices.

17. The edible non-animal dairy substitute product of any one of claims 1 to 16, further comprising an edible plant, or algae-based fat component, a fat component derived from fungi or yeast, in the range of up to 60 wt %, preferably up to 25 wt %, and most preferably from 1 wt % to 5 wt %.

18. The edible non-animal dairy substitute product of any one of claims 1 to 16, further comprising an edible plant, or algae-based fat component, a fat component derived from fungi or yeast, in the range of up to 25 wt %.

19. The edible non-animal dairy substitute product of any one of claims 1 to 16 further comprising an edible plant, or algae-based fat component, a fat component derived from fungi or yeast, in the range from 1 wt % to 5 wt %.

20. The edible non-animal dairy substitute product of any one of claims 17 to 19, wherein the edible plant-based fat component is selected from coconut oil, sunflower oil, rapeseed oil, palm oil, cotton seed oil, olive oil, canola oil, algae oil, or oleaginous yeast-derived oils.

21. The edible non-animal dairy substitute product of any one of claims 1 to 20, wherein the edible non-animal dairy substitute product is selected from products substituting milk, yoghurt, fresh cheese, whey cheese, cream cheese, medium-hard cheese, hard-cheese, and soft-mould cheese.

22. The edible non-animal dairy substitute product of any one of claims 1 to 21, wherein the edible fibrous mycelium has an insoluble fiber content of between 39% w/w and 60% w/w.

23. The edible non-animal dairy substitute product of any one of claims 1 to 21, wherein the edible fibrous mycelium has an insoluble fiber content of between 40% w/w and 55% w/w.

24. The edible non-animal dairy substitute product of any one of claims 1 to 21, wherein the edible fibrous mycelium has an insoluble fiber content of between 40% w/w and 50% w/w.

25. The edible non-animal dairy substitute product of any one of claims 1 to 21, wherein the edible fibrous mycelium has an insoluble fiber content of about 45% w/w.

26. The edible non-animal dairy substitute product of any one of claims 1 to 21, wherein the edible fibrous mycelium has an insoluble fiber content of at least 40%.

27. The edible non-animal dairy substitute product of any one of claims 1 to 21, wherein the edible fibrous mycelium has an insoluble fiber content of at least 50%.

28. The edible non-animal dairy substitute product of any one of claims 1 to 21, wherein the edible fibrous mycelium has an insoluble fiber content of at least 60%.

29. The edible non-animal dairy substitute product of any one of claims 1 to 28, wherein the edible fibrous mycelium has a fat content of 1 to 5 g per 100 g of said mycelium.

30. The edible non-animal dairy substitute product of any one of claims 1 to 28, wherein the edible fibrous mycelium has a fat content of 2 to 4 g per 100 g of said mycelium.

31. The edible non-animal dairy substitute product of any one of claims 1 to 28, wherein the edible fibrous mycelium has a fat content of 2 to 3.5 g per 100 g of said mycelium.

32. An edible fibrous mycelium derived from submerged fermentation having an insoluble fiber content of at least 39% w/w.

33. The edible fibrous mycelium of claim 32, wherein the edible fibrous mycelium has an insoluble fiber content of at least 40%.

34. The edible fibrous mycelium of claim 32, wherein the edible fibrous mycelium has an insoluble fiber content of at least 50%.

35. The edible fibrous mycelium of claim 32, wherein the edible fibrous mycelium has an insoluble fiber content of at least 60%.

36. The edible fibrous mycelium of claim 32, wherein the edible fibrous mycelium has an insoluble fiber content of between 39% w/w and 60% w/w.

37. The edible fibrous mycelium of claim 32, wherein the edible fibrous mycelium has an insoluble fiber content of between 40% w/w and 55% w/w.

38. The edible fibrous mycelium of claim 32, wherein the edible fibrous mycelium has an insoluble fiber content of between 40% w/w and 50% w/w.

39. The edible fibrous mycelium of claim 32, wherein the edible fibrous mycelium has an insoluble fiber content of about 45% w/w.

40. The edible fibrous mycelium of any one of claims 32 to 39, wherein the edible fibrous mycelium has a phosphorus content of at least 120 mg per 100 g weight, preferably at least 1000 mg per 100 g weight, more preferably at least 2000 mg per 100 g weight, for example 2131 mg per 100 g weight.

41. The edible fibrous mycelium of any one of claims 32 to 40, wherein the edible fibrous mycelium has a calcium content of at least 80 mg per 100 g weight, preferably 1000 mg per 100 g weight, for example 1331 mg per 100 g weight.

42. The edible fibrous mycelium of any one of claims 32 to 41, wherein the edible fibrous mycelium has a fat content of 1 to 5 g per 100 g of said mycelium.

43. The edible fibrous mycelium of any one of claims 32 to 41, wherein the edible fibrous mycelium has a fat content of 2 to 4 g per 100 g of said mycelium.

44. The edible fibrous mycelium of any one of claims 32 to 41, wherein the edible fibrous mycelium has a fat content of 2 to 3.5 g per 100 g of said mycelium.

45. Method of producing an edible non-animal dairy substitute product, the method comprising
a) homogenizing an edible fibrous mycelium mass with water, wherein optionally the edible fibrous mycelium mass is derived from submerged fermentation;
thereby obtaining an edible non-animal milk substitute product.

46. Method of claim 45, the method further comprising
b) heating the homogenized mixture to 25 to 95° C., preferably to 50° C.;
c) optionally adding a texturizing agent, such as agar-agar, edible starch, guar gum, locust bean gum, wheat gluten, cellulose or derivatives of it to the heated homogenized mixture of step b) and stirring the obtained mixture;
d) letting the mixture cool down to 20° C. to 45° C.;
e) adding acid-forming bacteria such as lactic acid bacteria culture or enzymes with protein-digesting properties;
f) mixing the mixture obtained after step e);
thereby obtaining an edible non-animal yoghurt substitute product.

47. Method of claim 45, further comprising:
b) heating the homogenized mixture to 25 to 95° C., preferably to 50° C.;
c) adding an edible plant, algae or fungi-based fat component in the range of up to 60 wt %, preferably up to 25 wt %, and most preferably from 1 wt % to 5 wt %;
d) homogenizing the mixture obtained after step c);
e) optionally adding a plant-based emulsifier such as lecithin, mono- and diglycerides, glycerides, monoglyceride derivatives, or fatty acid derivatives;
f) letting the mixture cool down to 20° C. to 45° C., preferably to 25° C. to 45° C., most preferably to 32° C. to 37° C.;
g) adding acid-forming bacteria in particular lactic acid bacteria culture or enzymes with protein-digesting properties;
h) mixing the mixture obtained after step g);
thereby obtaining an edible non-animal cheese substitute product, such as a fresh cheese substitute product, preferably after storing for 1-48 h at 1-37° C.

48. Method of claim 47, further comprising:
i) coagulating the mixture obtained after step h) of claim 11 by adding a coagulating agent to obtain a mixture of coagulated solids and liquids;
j) allowing the mixture obtained after step i) to settle;
k) separating the coagulated solids from the liquids;
I) storing the coagulated solids,
thereby obtaining an edible non-animal cheese substitute product selected from the group comprising an edible non-animal substitute product for whey cheese, cream cheese, medium-hard cheese, hard-cheese, and soft-mould cheese.

49. The method of claim 48, wherein the coagulating agent is a composition comprising a mineral or organic acid, such as lemon juice, or a non-animal based rennet comprising a mixture of enzymes derived from plants, bacteria or yeast.

50. The method of any one of claims 47 to 49, wherein the edible plant-based fat component is selected from coconut oil, sunflower oil, rapeseed oil, palm oil, cotton seed oil, olive oil, canola oil, algae oil, or oleaginous yeast-derived oils.

51. Use of an edible fibrous mycelium mass of claims 32 to 44 for producing an edible non-animal dairy substitute product, wherein the edible non-animal dairy substitute product is selected from products substituting milk, yoghurt, fresh cheese, whey cheese, cream cheese, medium-hard cheese, hard-cheese, and soft-mould cheese.

52. The edible non-animal dairy substitute product of any one of claims 1 to 31, or the edible fibrous mycelium mass of any one of claims 32 to 44, or the method of any one of claims to 50, or the use of claim 51, wherein the edible fibrous mycelium mass is obtained from at least one fungal strain selected from Basidiomycota, Ascomycota, Pezizomycotina, Agaromycotina, Pezizomycetes, Agaricomycetes, Sordariomycetes, Pezizales, Boletales, Cantharellales, Agaricales, Polyporales, Russulales, Auriculariales, Hypocreales, Morchellaceae, Tuberaceae, Pleurotaceae, Agaricaceae, Marasmiaceae, Cantharellaceae, Hydnaceae, Boletaceae, Meripilaceae, Polyporaceae, Strophariaceae, Lyophyllaceae, Tricholomataceae, Omphalotaceae, Physalacriaceae, Schizophyllaceae, Sclerodermataceae, Ganodermataceae, Sparassidaceae, Hericiaceae, Bondarzewiaceae, Cordycipitaceae, Auriculariaceae, and Fistulinacea.

53. The edible non-animal dairy substitute product, the edible fibrous mycelium mass, the method the use of claim 52, wherein the edible fibrous mycelium mass is obtained from at least one fungal strain selected from Basidiomycota, Ascomycota, Pezizomycotina, Agaromycotina, Agaricomycetes, Pezizales, Boletales, Cantharellales, Agaricales, Polyporales, Russulales, Auriculariales, Hypocreales, Morchellaceae, Tuberaceae, Pleurotaceae, Agaricaceae, Marasmiaceae, Cantharellaceae, Hydnaceae, Boletaceae, Meripilaceae, Polyporaceae, Strophariaceae, Lyophyllaceae, Tricholomataceae, Omphalotaceae, Physalacriaceae, Schizophyllaceae, Sclerodermataceae, Ganodermataceae, Sparassidaceae, Hericiaceae, Bondarzewiaceae, Cordycipitaceae, Auriculariaceae, and Fistulinacea

54. The edible non-animal dairy substitute product, the edible fibrous mycelium mass, the method the use of claim 52, wherein preferably the mycelium mass is obtained from Pleurotus pulmonarius, Pleurotus ostreatus, Pleurotus florida, Pleurotus citrinopileatus, Pleurotus salmoneostramineus, Morchella esculenta, Morchella angusticeps, or Morchella deliciosa, or Morchella rufobrunnea mycelium mass.

55. The edible non-animal dairy substitute product, the edible fibrous mycelium mass, the method the use of claim 52, wherein the edible fibrous mycelium mass is obtained from Pleurotus pulmonarius or Morchella rufobrunnea.

56. The edible non-animal dairy substitute product, the edible fibrous mycelium mass, the method the use of claim 52, wherein the edible fibrous mycelium mass is obtained from Pleurotus pulmonarius.

57. The edible non-animal dairy substitute product, the edible fibrous mycelium mass, the method the use of claim 52, wherein the edible fibrous mycelium mass is obtained from Morchella rufobrunnea.
